(19) United States
(12) Patent Application Publication
(10) Pub. No.: US 2007/0290483 A1
(43) Pub. Date: Dec. 20, 2007

(54) Vehicle tow bar

(76) Inventor: Dirk Jacobus Visser, Moreletta Park (ZA)

Correspondence Address: THOMAS, KAYDEN, HORSTEMEYER & RISLEY, LLP, 600 GALLERIA PARKWAY, STE 1500, ATLANTA, GA, 30339, US

(21) Appl. No.: 11/606,444

(22) Filed: Nov. 30, 2006

(30) Foreign Application Priority Data
Jun. 14, 2006 (ZA) 2006/04910

(51) Int. Cl. B60D 1/60

(52) U.S. Cl. 280/507

(57) ABSTRACT

A vehicle tow bar is provided which includes a harness and a flange, for the harness to be shaped and configured to be securable to a vehicle and for the flange to be shaped and configured for a hitch ball to be securable thereto, for the harness or the flange to include a receiver and the harness or the flange to include a complimentary shaped connector piece, for the connector piece to be receivable and securable in the receiver by means of a bolt which extends through a bolt passage in the receiver, for the tow bar to include means to rotate the bolt in the bolt passage between a first and a second position, and for the connection piece to include a formation shaped and configured to interfere with the bolt in the first position and to not interfere with the bolt in the second position.

### CROSS-REFERENCE TO RELATED APPLICATION

This application claims priority to South African Patent Application No. 2006/04910, filed Jun. 14, 2006, which is hereby incorporated by reference in its entirety into the present application.

### TECHNICAL FIELD

The present invention is generally related to a vehicle tow bar and more particularly to a lockable tow bar.

### BACKGROUND OF THE INVENTION

Tow bars such as those fitted on motor vehicles and the like normally include a harness which is secured to the vehicle and which includes a receiver. A flange is securable to the receiver and a hitch ball is in turn securable to the flange.

A problem with conventional tow bars is that for various reasons the flange and the receiver are removably secured to each other. This creates the possibility of easy removal of the flange, which makes it possible for thieves to remove the flange and hitch ball which is secured to it. In some instances it also leads to theft of a flange, hitch ball and a trailer coupled to the hitch ball.

A further problem with conventional tow bars is that the assembly of the tow bar is difficult due to misalignment of the flange and receiver. For these items to be connected they need to be aligned perfectly.

### OBJECT OF THE INVENTION

It is an object of the invention to provide a tow bar which at least partly overcomes the above-mentioned problems.

### SUMMARY OF THE INVENTION

In accordance with this invention there is provided a vehicle tow bar which includes a harness and a flange, for the harness to be shaped and configured to be securable to a vehicle and for the flange to be shaped and configured for a hitch ball to be securable thereto, for a first of the harness and the flange to include a receiver and for the second of the harness and the flange to include a complimentary shaped connector piece, for the connector piece to be receivable and securable in the receiver by means of a bolt which extends through a bolt passage in the receiver, for the tow bar to include means to rotate the bolt in the bolt passage between a first and a second position, and for the connection piece to include a formation shaped and configured to interfere with the bolt in the first position and to not interfere with the bolt in the second position.

There is further provided for the formation to comprise a groove, preferably having a semicircular shape, which extends transversely across the connection piece and coaxially with the bolt when the connection piece is fully received in the receiver.

There is still further provided for the bolt to comprise a right circular cylindrical bolt having a flattened face extending at least partly along its length, for the connection piece to include a flattened face extending at least partly along its length, and for rotation of the bolt from the first position to the second position to align the faces of the bolt and the connection piece.

There is still further provided for the first of the harness and the flange to preferably comprise the harness, and for the second of the harness and the flange to comprise the flange.

There is still further provided for the tow bar to include a threaded bolt extendable through a complimentary threaded aperture in the flange and for the end of the bolt to operatively bear against the receiver, and preferably for the end of the bolt to be at least partly extendable into a complimentary aperture in the receiver, and still further for the end of the bolt to be tapered and for the aperture in the receiver to be complimentary tapered.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

A preferred embodiment of the invention is described by way of example only and with reference to the accompanying drawings in which:

FIG. 1 is a perspective view of a preferred embodiment of a tow hitch flange and received of a tow hitch harness disconnected from each other;

FIG. 2 is a perspective view of the assembly of FIG. 1 with the tow hitch flange and receiver locked to each other;.

FIG. 3 is a part sectional side view of the tow hitch flange and receiver of the tow hitch harness disconnected from each other;

FIG. 4 is a part sectional side view of the tow hitch flange and receiver of the tow hitch harness locked to each other;

FIG. 5 is a side view of the tow hitch flange and receiver of the tow hitch harness locked to each other showing the lock; and

FIG. 6 is a sectional plan view of the tow hitch flange and receiver of the tow hitch harness locked to each other showing the lock.

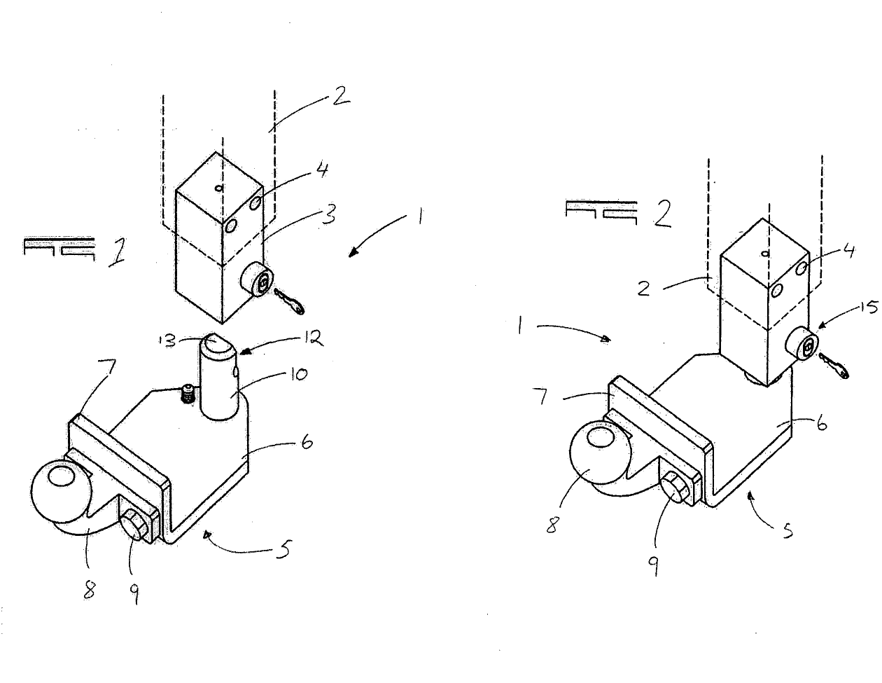

### DETAILED DESCRIPTION OF THE INVENTION

A preferred embodiment of a tow hitch assembly (1) is shown in the drawings.

The tow hitch assembly (1) includes a harness (2) which is secured to a vehicle (not shown), normally by means of heavy duty bolts. A receiver (2) is secured to the harness (2), also by means of heavy duty bolts or the like (not shown), which extend through apertures (4) in the top of the receiver (3). Operatively, the receiver (3) extends vertically downward from the harness (2).

The assembly includes a flange (5) with a base (6) and an angled face plate (7). The face plate (7) has a set of apertures and a tow hitch ball (8) is bolted (9) to the face plate (7). A cylindrical connection piece (10) extends from the base (6), and the flange (5) is securable to the receiver (3) by pushing the connection piece (10) into the receiver (3). The receiver (3) has a cylindrically shaped receptacle (11) complimentary to the cylindrical connection piece (10). A section of the connection piece (10) is flattened to a face (12) from the free end (13) of the connection piece (10) inwards to about half the length of the connection piece (10). At the end of the flattened face (12), a groove (14) is machined across the flattened face (12).

The receiver also includes a bolt-and-lock assembly (15). The bolt-and-lock assembly (15) comprises a cylindrical housing (16) extending from the receiver (3) and which securely houses a lock (17). The keyhole (18) to the lock (17) is accessible through the end of the housing (16), where a protective cap (not shown) is used to seal the lock (17) and keyhole (18) against dust and moisture.

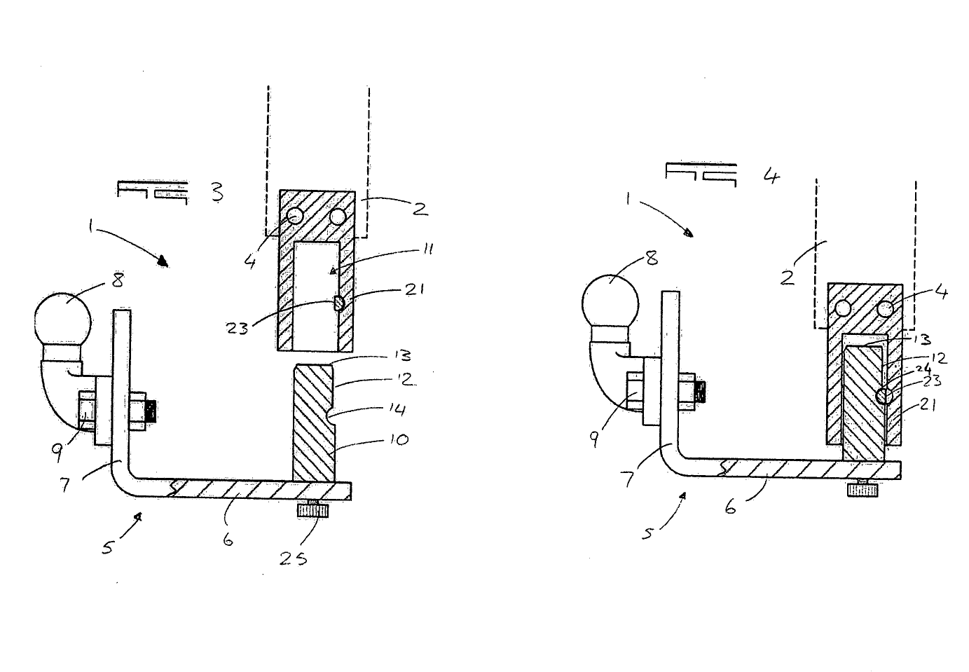

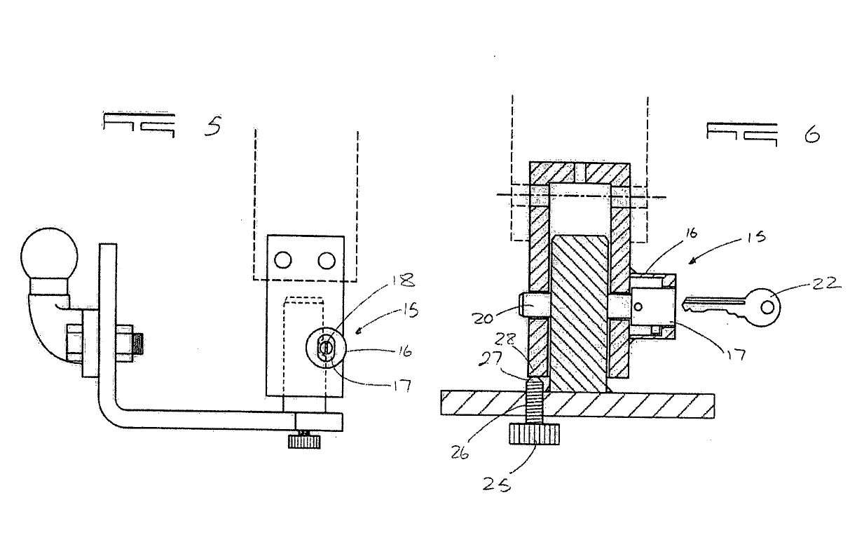

The lock (17) is rotatably connected to a bolt (20) which extends along one sidewall (21) of the receiver (3) through the cylindrical receptacle (11). The bolt (20) is rotatable in the receiver (3) by means of the lock (17), through the use of the key (22) in the lock (17). The bolt (20) includes a flattened face (23) which extends partly along the length of the bolt (20). Rotation of the lock (17) rotates the bolt (20) between a first position, as shown in FIG. 3, to a second position, as shown in FIG. 4, relative to the flattened face (12) on the connection piece (10). In the first position, which is a non-interference position, the flattened face (23) of the bolt (20) is completely aligned with the flattened face (12) of the connection piece (10), which allows free passage of the connection piece (10) into and out of the receptacle (11). In the second position, which is an interference position, the flattened face (23) of the bolt (20) is rotated at an orientation other than completely in line with the flattened face (12) of the connection piece (10).

Once the connection piece (10) extends fully into the receptacle (11) the bolt (20) is axially aligned with the groove (14) in the connection piece (10). The lock (17) is then used to rotate the bolt (20), which brings the bolt (20) into its interference position relative to the flattened face (12) of the connection piece (10), thereby locking the connection piece (10) and receiver (3) to each other. In the interference position the side (24) of the groove (14) which leads into the flattened face (12) of the connection piece (10), bears against the non-flattened side of the bolt (20) and prevents relative movement between the connection piece (10) and the receiver (3).

To remove the connection piece (10) from the receiver (3) the key is used to rotate the lock (17), which rotates the bolt (20) into the non-interference position and allows the connection piece (10) to be extracted from the receptacle (11).

In an alternative embodiment (not shown), the receiver (3) is secured to the base (6) of the flange (5) by means of heavy bolts or the like which extend into apertures in the bottom of the receiver (3). In this embodiment the cylindrical connection piece (10) extends from the harness (2) to which it is secured by means of heavy bolts or the like.

The assembly (1) also includes a rattle eliminator in the form of a screw threaded bolt (25) which extends through a threaded aperture (26) in the base (6) of the flange (5) alongside the connection piece (10). The bolt (25) has a tapered tip (27). The receiver (3) includes a complimentary shaped tapered aperture (28) within which the tip (27) of the bolt (25) is receivable. Once the connection piece (10) has been extended into the receptacle (11) and the receiver (3) and connection piece (10) locked together, the bolt (25) is extended until the tip (27) bears against the tapered aperture (28). This forces one side of the lock bolt (20) to bear against one side of the groove (24), which prevents movement that may otherwise have taken place due to minor differences in the diameter of the lock bolt (20) and the diameter of the groove (24). This also serves to protect the lock bolt (20) and lock (17) from impacts which may be damaging to the lock mechanism.

With this configuration it is possible to securely lock a tow hitch flange (5) to a harness (2) which allows for quick removal but still prevent unauthorised removal of the flange (5).

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A vehicle tow bar which includes a harness and a flange, the harness being shaped and configured to be securable to a vehicle and the flange being shaped and configured for a hitch ball to be securable thereto, a first of the harness and the flange includes a receiver and the second of the harness and the flange includes a complimentary shaped connector piece, the connector piece being receivable and securable in the receiver by means of a bolt which extends through a bolt passage in the receiver, the tow bar includes means to rotate the bolt in the bolt passage between a first and a second position, and the connection piece includes a formation shaped and configured to interfere with the bolt in the first position and to not interfere with the bolt in the second position.

2. A vehicle tow bar as claim in claim 1 in which the formation comprises a groove which extends transversely across the connection piece and coaxially with the bolt when the connection piece is fully received in the receiver.

3. A vehicle tow bar as claimed in claim 2 in which the groove is semi-circular shaped.

4. A vehicle tow bar as claimed in claim 2 in which the bolt comprises a right circular cylindrical bolt with a flattened face which extends at least partly along its length, the connection piece includes a flattened face which extends at least partly along its length, and rotation of the bolt from the first position to the second position aligns the faces of the bolt and the connection piece.

5. A vehicle tow bar as claimed in claim 3 in which the bolt comprises a right circular cylindrical bolt with a flattened face which extends at least partly along its

5. A vehicle tow bar as claimed in claim 3 in which the bolt comprises a right circular cylindrical bolt with a flattened face which extends at least partly along its length, the connection piece includes a flattened face which extends at least partly along its length, and rotation of the bolt from the first position to the second position aligns the faces of the bolt and the connection piece.

6. A vehicle tow bar as claimed in claim 1 in which the first of the harness and the flange comprises the harness, and the second of the harness and the flange comprises the flange.

7. A vehicle tow bar as claim in claim 1 which further includes a threaded bolt extendable through a complimentary threaded aperture in the flange and the end of the bolt operatively bears against the receiver.

8. A vehicle tow bar as claim in claim 6 which further includes a threaded bolt extendable through a complimentary threaded aperture in the flange and the end of the bolt operatively bears against the receiver.

9. A vehicle tow bar as claimed in claim 8 in which the end of the bolt is at least partly extendable into a complimentary aperture in the receiver.

10. A vehicle tow bar as claimed in claim 9 in which the end of the bolt is tapered and the aperture in the receiver is complimentary tapered.

11. A vehicle tow bar which includes a harness and a flange, the harness being shaped and configured to be securable to a vehicle and the flange being shaped and configured for a hitch ball to be securable thereto, the harness includes a receiver and the flange includes a complimentary shaped connector piece, the connector piece being receivable and securable in the receiver by means of a bolt which extends through a bolt passage in the receiver, the tow bar includes means to rotate the bolt in the bolt passage between a first and a second position, and the connection piece includes a formation shaped and configured to interfere with the bolt in the first position and to not interfere with the bolt in the second position.

12. A vehicle tow bar as claim in claim 11 in which the formation comprises a groove which extends transversely across the connection piece and coaxially with the bolt when the connection piece is fully received in the receiver.

13. A vehicle tow bar as claimed in claim 12 in which the groove is semi-circular shaped.

14. A vehicle tow bar as claimed in claim 12 in which the bolt comprises a right circular cylindrical bolt with a flattened face which extends at least partly along its length, the connection piece includes a flattened face which extends at least partly along its length, and rotation of the bolt from the first position to the second position aligns the faces of the bolt and the connection piece.

15. A vehicle tow bar as claimed in claim 13 in which the bolt comprises a right circular cylindrical bolt with a flattened face which extends at least partly along its length, the connection piece includes a flattened face which extends at least partly along its length, and rotation of the bolt from the first position to the second position aligns the faces of the bolt and the connection piece.

16. A vehicle tow bar as claim in claim 11 which further includes a threaded bolt extendable through a complimentary threaded aperture in the flange and the end of the bolt operatively bears against the receiver.

17. A vehicle tow bar as claimed in claim 16 in which the end of the bolt is at least partly extendable into a complimentary aperture in the receiver.

18. A vehicle tow bar as claimed in claim 17 in which the end of the bolt is tapered and the aperture in the receiver is complimentary tapered.

19. A vehicle tow bar which includes a harness and a flange, the harness being shaped and configured to be securable to a vehicle and the flange being shaped and configured for a hitch ball to be securable thereto, the flange includes a receiver and the harness includes a complimentary shaped connector piece, the connector piece being receivable and securable in the receiver by means of a bolt which extends through a bolt passage in the receiver, the tow bar includes means to rotate the bolt in the bolt passage between a first and a second position, and the connection piece includes a formation shaped and configured to interfere with the bolt in the first position and to not interfere with the bolt in the second position.

20. A vehicle tow bar as claim in claim 19 in which the formation comprises a groove which extends transversely across the connection piece and coaxially with the bolt when the connection piece is fully received in the receiver.

21. A vehicle tow bar as claimed in claim 20 in which the bolt comprises a right circular cylindrical bolt with a flattened face which extends at least partly along its length, the connection piece includes a flattened face which extends at least partly along its length, and rotation of the bolt from the first position to the second position aligns the faces of the bolt and the connection piece.
